(19) United States
(12) Patent Application Publication
(10) Pub. No.: US 2017/0200164 A1
(43) Pub. Date: Jul. 13, 2017

(54) APPARATUS AND METHOD FOR DETECTING FRAUDULENT TRANSACTION USING MACHINE LEARNING

(71) Applicant: KOREA INTERNET & SECURITY AGENCY, Seoul (KR)

(72) Inventors: Eun Young CHOI, Seoul (KR); Woong GO, Seoul (KR); Mi Joo KIM, Seoul (KR); Tae Jin LEE, Seoul (KR)

(21) Appl. No.: 15/006,541

(22) Filed: Jan. 26, 2016

(30) Foreign Application Priority Data
Jan. 8, 2016 (KR) 10-2016-0002666

(51) Int. Cl. G06Q 20/40; G06N 99/00

(52) U.S. Cl. CPC G06Q 20/4016; G06N 99/005

(57) ABSTRACT

Provided are an apparatus and method for detecting a fraudulent transaction using machine learning. The apparatus for detecting a fraudulent transaction using machine learning includes a settlement information input unit configured to receive settlement information of a user device in response to a settlement request from the user device, a feature information extraction unit configured to extract feature information from the received settlement information, and a fraudulent transaction determination unit configured to determine whether a transaction is a fraudulent transaction or not using a plurality of machine learning algorithms based on the extracted feature information.

### CROSS REFERENCE TO RELATED APPLICATION

The present application claims the benefit of Korean Patent Application No. 10-2016-0002666 filed in the Korean Intellectual Property Office on Jan. 8, 2016, the entire contents of which are incorporated herein by reference.

### BACKGROUND OF THE INVENTION

1. Technical Field

The present invention relates to a technology for detecting a fraudulent transaction and, more particularly, to an apparatus and method for detecting a fraudulent transaction using a plurality of machine learning algorithms.

2. Description of the Related Art

In the Korean/foreign financial world, a fraud detection system (FDS) is constructed and managed. In most of FDS technologies, a scenario is derived based on passive analysis of past accident information, ruled, and used to detect post-fraudulent transactions. In Korea, FDSs are constructed and used, but a current FDS has a very low function and accuracy.

A machine learning technology for automatically constructing fraudulent transaction detection logic based on learning has been proposed as an FDS-advanced technology for securing safety for a financial accident that continues to become intelligent. In Korea, a fraudulent financial transaction detection system technology guidance proposing the application of such a machine learning technology has been supplied, but does not support a machine learning technology in a technology term.

Furthermore, current Korean FDS companies remain in a ruled information-based detection technology, such as an Internet protocol (IP) address, and thus the development of a machine learning technology is insufficient.

### SUMMARY OF THE INVENTION

Accordingly, the present invention has been made keeping in mind the above problems occurring in the prior art, and an object of the present invention is to provide an apparatus and method for detecting a fraudulent transaction using machine learning, wherein settlement information is analyzed in response to a settlement request, a plurality of pieces of feature information is extracted based on the results of the analysis, the extracted feature information is learnt using a plurality of machine learning algorithms, and whether a transaction is a fraudulent transaction or not is determined based on the results of the learning.

Objects to be achieved by the present invention are not limited to the aforementioned object, and those skilled in the art to which the present invention pertains may evidently understand other technical objects from the following description.

In an aspect of the present invention, an apparatus for detecting a fraudulent transaction using machine learning may include a settlement information input unit configured to receive settlement information of a user device in response to a settlement request from the user device, a feature information extraction unit configured to extract feature information from the received settlement information, and a fraudulent transaction determination unit configured to determine whether a transaction is a fraudulent transaction or not using a plurality of machine learning algorithms based on the extracted feature information.

The fraudulent transaction determination unit is configured to apply the received feature information to each of the plurality of machine learning algorithms, determine whether the transaction is the fraudulent transaction or not based on a result of the application, and determine one final fraudulent transaction using the results of the determination of the plurality of fraudulent transactions.

The plurality of machine learning algorithms comprises a decision tree classification algorithm, a random forest classification algorithm, and a support vector machine (SVM) classification algorithm.

The feature information extraction unit is configured to extract a plurality of pieces of the feature information from the received settlement information of the user device and to change the extracted feature information in the form of data for input of the machine learning algorithms.

The feature information extraction unit is configured to extract the plurality of pieces of feature information based on features derived from the settlement information using a heuristics or feature selection algorithm.

The feature information comprises at least one of a communication service providing company, a corporate body ID, a store ID, a transaction amount, a service ID, an authentication date, an authentication time, country information of Internet Protocol (IP) information, a sales type, and a transaction amount section.

In another aspect of the present invention, a method for detecting a fraudulent transaction using machine learning may include receiving settlement information of a user device in response to a settlement request from the user device, extracting feature information from the received settlement information, and determining whether a transaction is a fraudulent transaction or not using a plurality of machine learning algorithms based on the extracted feature information.

Determining whether the transaction is the fraudulent transaction or not includes applying the received feature information to each of the plurality of machine learning algorithms, determining whether the transaction is the fraudulent transaction or not based on a result of the application, and determining one final fraudulent transaction using the results of the determination of the plurality of fraudulent transactions.

Extracting the feature information includes extracting a plurality of pieces of the feature information from the received settlement information of the user device and changing the extracted feature information in the form of data for input of the machine learning algorithms.

Extracting the feature information includes extracting the plurality of pieces of feature information based on features derived from the settlement information using a heuristics or feature selection algorithm.

### BRIEF DESCRIPTION OF THE DRAWINGS

FIG. 1 is a diagram showing a schematic configuration of a system according to an embodiment of the present invention.

FIG. 2 is a diagram showing an apparatus for detecting a fraudulent transaction according to an embodiment of the present invention.

FIG. 3 is a diagram showing a plurality of machine learning algorithms according to an embodiment of the present invention.

FIG. 4 is a diagram showing a process of detecting a fraudulent transaction according to an embodiment of the present invention.

FIG. 5 is a diagram showing a method for detecting a fraudulent transaction according to an embodiment of the present invention.

FIG. 6 is a diagram showing the results of tests of fraudulent transaction detection performance according to an embodiment of the present invention.

### DETAILED DESCRIPTION

Hereinafter, an apparatus and method for detecting a fraudulent transaction using machine learning according to embodiments of the present invention are described in detail with reference to the accompanying drawings. Portions required for the understanding of operations and actions according to the embodiments of the present invention are chiefly described.

Furthermore, in describing the elements of the present invention, different reference numerals may be assigned to elements having the same name depending on the drawings, and the same reference numeral may be assigned to elements in different drawings. However, it does not mean that a corresponding element has a different function depending on an embodiment and has the same function in different embodiments. The function of each element should be determined based on a description of each element in a corresponding embodiment.

In particular, an embodiment of the present invention proposes a new method for analyzing settlement information in response to a settlement request, extracting a plurality of pieces of feature information based on the results of the analysis, learning the extracted feature information using a plurality of machine learning algorithms, and determining whether a transaction is a fraudulent transaction or not based on the results of the learning.

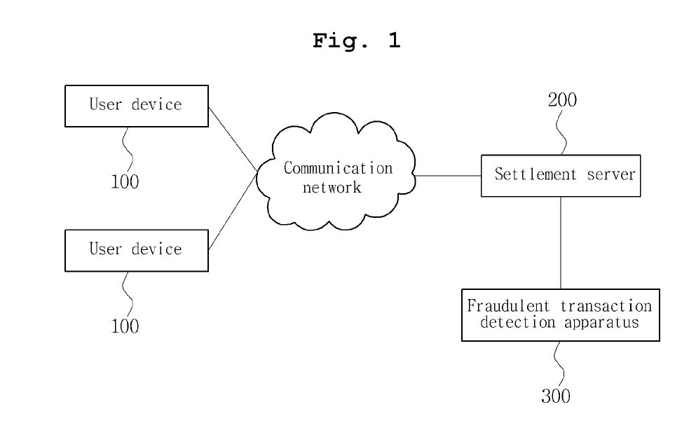

FIG. 1 is a diagram showing a schematic configuration of a system according to an embodiment of the present invention.

As shown in FIG. 1, the system according to an embodiment of the present invention may include a user device 100, a settlement server 200, and an apparatus for detecting a fraudulent transaction (hereinafter referred to as a “fraudulent transaction detection apparatus”) 300.

The user device 100 is a device used by a user and may make a real-time settlement. The user device 100 may be a concept including a mobile phone, a tablet PC, and a PC.

The settlement server 200 may receive settlement information according to a settlement request from the user device 100 while operating in conjunction with the user device 100, may perform authentication on the received settlement information, and may provide an authentication number or determine the blocking of settlement based on a result of the authentication.

The fraudulent transaction detection apparatus 300 may receive settlement information from the settlement server 200 in real time while operating in conjunction with the settlement server 200, may determine whether a transaction is a fraudulent transaction or not using the received settlement information, and may provide a result of the determination to the settlement server 200.

The fraudulent transaction detection apparatus 300 may analyze settlement information received from the settlement server 200, may extract a plurality of pieces of feature information based on the results of the analysis, may learn the extracted feature information using a plurality of machine learning algorithms, and may determine whether a transaction is a fraudulent transaction or not based on the results of the learning.

The fraudulent transaction detection apparatus 300 may provide the settlement server 200 with information about whether a transaction is a fraudulent transaction or not so that the settlement server 200 is able to send an authentication number or block settlement.

In an embodiment of the present invention, the settlement server 200 and the fraudulent transaction detection apparatus 300 may be implemented using physically separated devices, but are not limited thereto. For example, the settlement server 200 and the fraudulent transaction detection apparatus 300 may be implemented using one combined device.

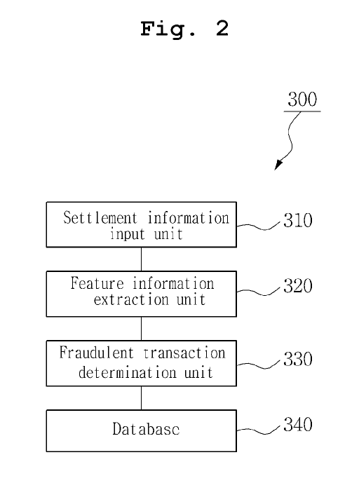

FIG. 2 is a diagram showing an apparatus for detecting a fraudulent transaction according to an embodiment of the present invention.

As shown in FIG. 2, the fraudulent transaction detection apparatus 300 according to an embodiment of the present invention may include a settlement information input unit 310, a feature information extraction unit 320, a fraudulent transaction determination unit 330, and a database 340.

The settlement information input unit 310 may receive settlement information of the user device 100 from the settlement server 200.

The feature information extraction unit 320 may extract predetermined feature information from the received settlement information. The feature information may have been previously determined and is illustrated in Table 1.

TABLE 1

| TYPE | FIELD NAME | DESCRIPTION |
|---|---|---|
| 1 | COMM_ID | Communication service providing company |
| 2 | ENTP_ID | Corporate body ID |
| 3 | MCHT_ID | Store ID |
| 4 | PRDT_PRICE | Transaction amount |
| 5 | SVC_ID_K_e | service ID |
| 6 | APPR_DT | Authentication date |
| 7 | APPR_TM | Authentication time |
| 8 | IP_Country | Country information of IP information |
| 9 | MAECHUL_GB | Type of sales |
| 10 | Price_Section | Transaction amount section |

As described above, in an embodiment of the present invention, the 10 pieces of feature information may be extracted as in Table 1.

In this case, the feature information extraction unit 320 may extract the feature information based on features derived from the settlement information using a heuristics or feature selection algorithm.

The heuristics algorithm may be method capable of analyzing and deriving features based on in-depth analysis in order to minimize the possibility that similar features may be redundantly selected.

Furthermore, the feature selection algorithm may be a method capable of extracting features based on an automated feature selection algorithm for deriving all of available items through distribution analysis.

For example, the feature selection algorithm may be cfsSubsetEval or ChiSquaredAtttibuteEval.

Furthermore, the feature information extraction unit 320 may change the data form of the extracted feature information. The reason for this is that some pieces of information that belong to the settlement information and that have continuity, such as a settlement amount and a transaction date, or that they are difficult to be used as input to the machine learning algorithm.

For example, the type of data of the authentication date, transaction date, or cancellation date may be changed for each day. The type of hour/minute/second of the authentication time, transaction time, or cancellation time may be changed every hour. C class band information about the user IP may be changed for each country. The service type information may be changed from a Korean type to an English type, for example. The type of Korean Won of the transaction amount may be clustered into five groups and matched.

The fraudulent transaction determination unit 330 may receive the extracted feature information, may learn the received feature information using the plurality of machine learning algorithms, and may determine whether a transaction is a fraudulent transaction or not based on the results of the learning.

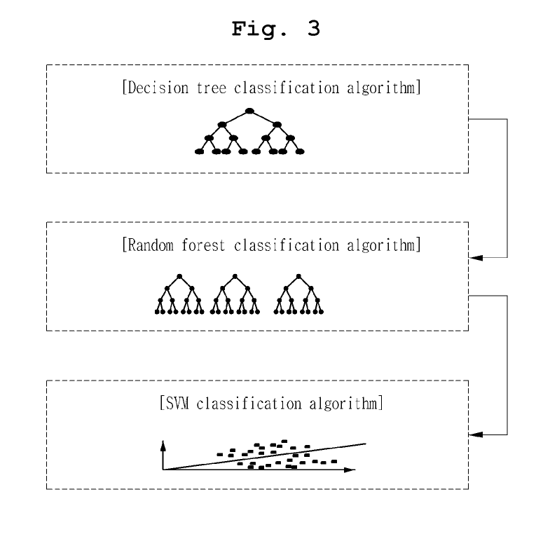

FIG. 3 is a diagram showing a plurality of machine learning algorithms according to an embodiment of the present invention.

As shown in FIG. 3, in an embodiment of the present invention, in order to improve the accuracy of classification results, an ensemble structure including a plurality of complementary machine learning algorithms may be used. The ensemble structure may include a plurality of machine learning algorithms, for example, three machine learning algorithms.

For example, the three machine learning algorithms may include a decision tree (DT) classification algorithm, a random forest (RF) classification algorithm, and a support vector machine (SVM) classification algorithm.

The DT classification algorithm is a method for deriving the results by learning a tree structure and is advantageous in that the results can be easily analyzed and understood, data processing speed is fast, and the results can be derived based on a search tree.

The RF classification algorithm may be used as a method for improving low classification accuracy of the DT classification algorithm.

The RF classification algorithm is a method for deriving the results learnt using a plurality of DTs as an ensemble. The RF classification algorithm is disadvantageous in that the results of the algorithm are difficult to be understood compared to the DT classification algorithm, but accuracy of the results thereof may be high compared to the DT classification algorithm.

The SVM classification algorithm may be used as a method for improving over-fitting which may be generated due to the learning of the DT or RF classification algorithm.

The SVM classification algorithm is a method for classifying data belonging to different classifications based on a plane. In general, the SVM classification algorithm may have high accuracy and have low sensitivity for over-fitting in structure.

An algorithm, which is chiefly applied to the fraudulent transaction detection field, whose results can be easily analyzed, and which has high performance, may be selected as a machine learning algorithm according to an embodiment of the present invention.

In an embodiment of the present invention, the three machine learning algorithms are illustrated as being used as an example, but the present invention is not necessarily limited thereto. The number of machine learning algorithms may be changed, if necessary.

In accordance with an embodiment of the present invention, settlement information of 10,000 learning samples may be learnt based on the constructed ensemble structure, and a system optimized for a mobile micropayments settlement environment may be constructed based on the results of the learning.

In this case, the ratio of normal transactions versus fraudulent transactions of mobile settlement information may be 8:2.

The fraudulent transaction determination unit 330 may apply the received feature information to each of the plurality of machine learning algorithms and may determine whether a transaction is a fraudulent transaction or not based on a result of the application.

The fraudulent transaction determination unit 330 may determine a single final fraudulent transaction based on the results of a plurality of fraudulent transactions determined using the plurality of machine learning algorithms.

The database 340 may store the settlement information, the feature information, and the results of the determination of the fraudulent transactions.

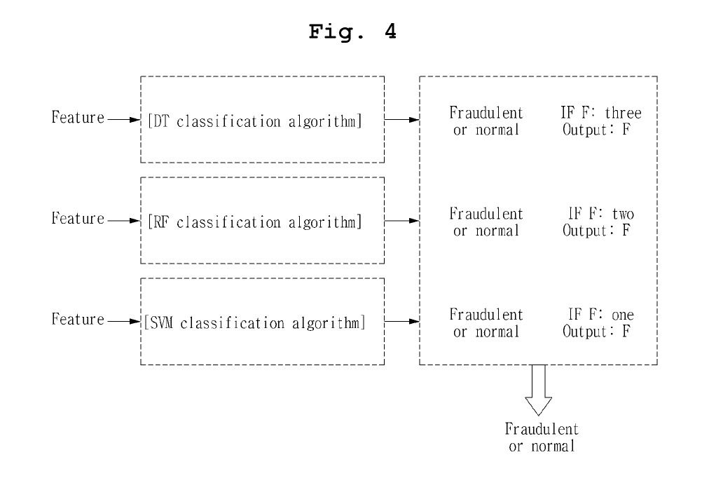

FIG. 4 is a diagram showing a process of detecting a fraudulent transaction according to an embodiment of the present invention.

As shown in FIG. 4, in an embodiment of the present invention, real-time settlement information may be received. 10 pieces of feature information extracted from the settlement information may be applied to the plurality of machine learning algorithms, that is, the DT classification algorithm, the RF classification algorithm, and the SVM classification algorithm.

Whether a transaction is a fraudulent transaction or not may be determined using each of the plurality of machine learning algorithms.

In other words, whether a transaction is a fraudulent transaction may be determined using the DT classification algorithm. Whether a transaction is a fraudulent transaction may be determined using the RF classification algorithm. Whether a transaction is a fraudulent transaction may be determined using the SVM classification algorithm.

The final fraudulent transaction, that is, whether a transaction is a fraudulent transaction or a normal transaction, may be determined based on the results of the fraudulent transactions determined using the plurality of machine learning algorithms.

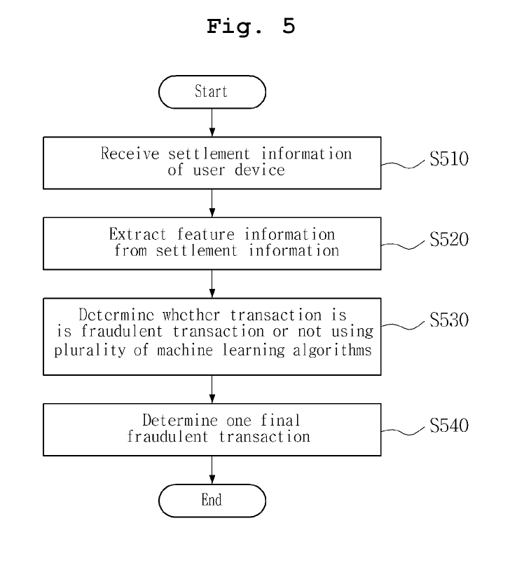

FIG. 5 is a diagram showing a method for detecting a fraudulent transaction according to an embodiment of the present invention.

As shown in FIG. 5, the fraudulent transaction detection apparatus 300 according to an embodiment of the present invention may receive settlement information of the user device 100 from the settlement server 200 at step S510.

The fraudulent transaction detection apparatus 300 may extract predetermined feature information from the received settlement information at step S520.

The fraudulent transaction detection apparatus 300 may apply the received feature information to the plurality of machine learning algorithms and may determine whether a transaction is a fraudulent transaction or not based on the results of the application at step S530.

The fraudulent transaction detection apparatus 300 may determine one final fraudulent transaction based on the results of the plurality of fraudulent transactions determined using the plurality of machine learning algorithms at step S540.

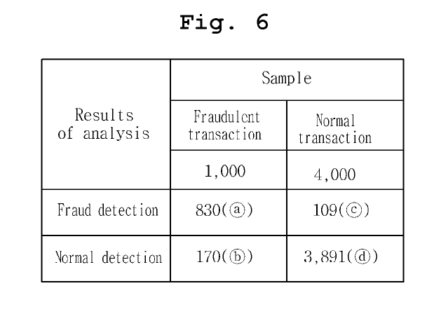

FIG. 6 is a diagram showing the results of tests of fraudulent transaction detection performance according to an embodiment of the present invention.

As shown in FIG. 6, the fraudulent transaction detection apparatus 300 according to an embodiment of the present invention has classification accuracy of 94.4% based on the results of tests on the classification accuracy using a total of 5,000 cases including 4,000 normal transactions and 1,000 fraudulent transactions.

For example, in classification accuracy of the system, a ratio of the total of 5,000 transactions to correct classifications may be calculated as “(\textcircled{a}+\textcircled{d})/5,000=(830+3,891)/5,000=94.42%.”

Furthermore, a system erroneous detection ratio is the ratio of the total of 5,000 transactions to erroneous classifications, that is, the sum of a non-detection ratio and an over detection ratio, and may be calculated as “(\textcircled{b}+\textcircled{c})/5,000=(170+109)/5,000=5.58%.”

Although all of the elements forming the embodiments of the present invention may have been illustrated as being combined into one or as operating as a unity, the present invention is not necessarily limited to such embodiments. That is, one or more of all of the elements may be selectively combined and may operate within the scope of the present invention. Furthermore, each of all of the elements may be implemented using independent hardware, but some or all of the elements may be selectively combined and implemented as a computer program having a program module for performing the function of some or all of elements combined in a piece of or a plurality of pieces of hardware. Furthermore, such a computer program may be stored in computer-readable media, such as USB memory, a CD disk, or flash memory, and may read and executed by a computer, thereby implementing an embodiment of the present invention. The storage medium of the computer program may include a magnetic recording medium, an optical recording medium, and a carrier wave medium.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

As described above, in accordance with the embodiments of the present invention, settlement information is analyzed in response to a settlement request. A plurality of pieces of feature information is extracted based on the results of the analysis. The extracted feature information is learnt using the plurality of machine learning algorithms. Whether a transaction is a fraudulent transaction or not based on the results of the learning. Accordingly, there is an advantage that a settlement pattern can be flexibly handled.

Furthermore, in accordance with the embodiments of the present invention, a changing settlement pattern can be flexibly handled using the ensemble structure including the plurality of machine learning algorithms. Accordingly, there is an advantage that reliability of the results of detection can be secured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for detecting a fraudulent transaction using machine learning, comprising:
a settlement information input unit configured to receive settlement information of a user device in response to a settlement request from the user device;
a feature information extraction unit configured to extract feature information from the received settlement information; and
a fraudulent transaction determination unit configured to determine whether a transaction is a fraudulent transaction or not using a plurality of machine learning algorithms based on the extracted feature information.

2. The apparatus of claim 1, wherein the fraudulent transaction determination unit is configured to apply the received feature information to each of the plurality of machine learning algorithms, determine whether the transaction is the fraudulent transaction or not based on a result of the application, and determine one final fraudulent transaction using the results of the determination of the plurality of fraudulent transactions.

3. The apparatus of claim 2, wherein the plurality of machine learning algorithms comprises a decision tree classification algorithm, a random forest classification algorithm, and a support vector machine (SVM) classification algorithm.

4. The apparatus of claim 1, wherein the feature information extraction unit is configured to extract a plurality of pieces of the feature information from the received settlement information of the user device and to change the extracted feature information in a form of data for input of the machine learning algorithms.

5. The apparatus of claim 4, wherein the feature information extraction unit is configured to extract the plurality of pieces of feature information based on features derived from the settlement information using a heuristics or feature selection algorithm.

6. The apparatus of claim 4, wherein the feature information comprises at least one of a communication service providing company, a corporate body ID, a store ID, a transaction amount, a service ID, an authentication date, an authentication time, country information of Internet Protocol (IP) information, a sales type, and a transaction amount section.

7. A method for detecting a fraudulent transaction using machine learning, the method comprising:
receiving settlement information of a user device in response to a settlement request from the user device;
extracting feature information from the received settlement information; and
determining whether a transaction is a fraudulent transaction or not using a plurality of machine learning algorithms based on the extracted feature information.

8. The method of claim 7, wherein determining whether the transaction is the fraudulent transaction or not comprises:
applying the received feature information to each of the plurality of machine learning algorithms,
determining whether the transaction is the fraudulent transaction or not based on a result of the application, and
determining one final fraudulent transaction using the results of the determination of the plurality of fraudulent transactions.

9. The method of claim 8, wherein the plurality of machine learning algorithms comprises a decision tree classification algorithm, a random forest classification algorithm, and a support vector machine (SVM) classification algorithm.

10. The method of claim 7, wherein extracting the feature information comprises:
extracting a plurality of pieces of the feature information from the received settlement information of the user device, and
changing the extracted feature information in a form of data for input of the machine learning algorithms.

11. The method of claim 10, wherein extracting the feature information comprises extracting the plurality of pieces of feature information based on features derived from the settlement information using a heuristics or feature selection algorithm.

12. The method of claim 10, wherein the feature information comprises at least one of a communication service providing company, a corporate body ID, a store ID, a transaction amount, a service ID, an authentication date, an authentication time, country information of Internet Protocol (IP) information, a sales type, and a transaction amount section.
